(19) United States
(12) Patent Application Publication
(10) Pub. No.: US 2008/0283132 A1
(43) Pub. Date: Nov. 20, 2008

(54) GASKET WITH INTERNAL SCREEN AND METHOD OF MANUFACTURING THE SAME

(75) Inventors: Philip W. Katzer, Ames, IA (US); Kevin J. Landhuis, Ankeny, IA (US); Christian Preutenborbeck, Aukrug-Homfeld (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/749,410

(22) Filed: May 16, 2007

(51) Int. Cl. B01D 39/10; B23P 15/16

(52) U.S. Cl. 137/550; 29/896.62

(57) ABSTRACT

A gasket for a hydraulic housing and a method of manufacturing the same. The gasket is made by taking a metal body having a first and second side and coating the first and second side with rubber. An area of the rubber is then burned off by a laser and then in that area the laser is used to create a plurality of openings that act to filter hydraulic fluid that flows through the gasket.

### BACKGROUND OF THE INVENTION

This invention relates to a hydraulic unit. More specifically, this invention relates to a gasket for a hydraulic pump and a method for manufacturing the same.

Within a hydraulic unit often times screens are used to block particles of contamination that can be carried by fluid into the control of the hydraulic unit. Known in the art are screens that are made of a turned steel body with wire mesh inserted into the part and then the steel carrier is crimped or swaged to retain the wire mesh. (FIG. 3). The steel body is then pressed into the control housing. The screen adds cost due to additional parts and added time in the manufacturer of the control and pump assembly. Additionally, on occasion small wires from the wire mesh can dislodge from the screen and contaminate the hydraulic fluid.

Thus, a principal object of the present invention is to eliminate the need for separate wire mesh screens to filter hydraulic fluid.

Yet another object of the present invention is to provide a manufacturing method of making an improved gasket for a hydraulic unit.

These and other features, objects, and advantages will become apparent from the specification and claims.

### BRIEF SUMMARY OF THE INVENTION

A gasket for a hydraulic housing having a metal body with first and second sides. There is a coat of rubber that is placed on the first and second sides. A laser is then used to burn the rubber off of an area on the metal body and a plurality of laser made openings are created within the metal body in this area.

### BRIEF DESCRIPTION OF THE DRAWINGS

FIG. 1 is a side plan view of a hydraulic housing with gasket;

FIG. 2 is a side perspective view of a gasket and a laser;

FIG. 2A is an exploded perspective view of a portion of a gasket taken along the lines 2A of FIG. 2;

FIG. 2B is a side plan view of a portion of a gasket taken along the lines 2B of FIG. 2; and

FIG. 3 is a side perspective view of a prior art gasket.

### DETAILED DESCRIPTION OF THE PREFERRED EMBODIMENT

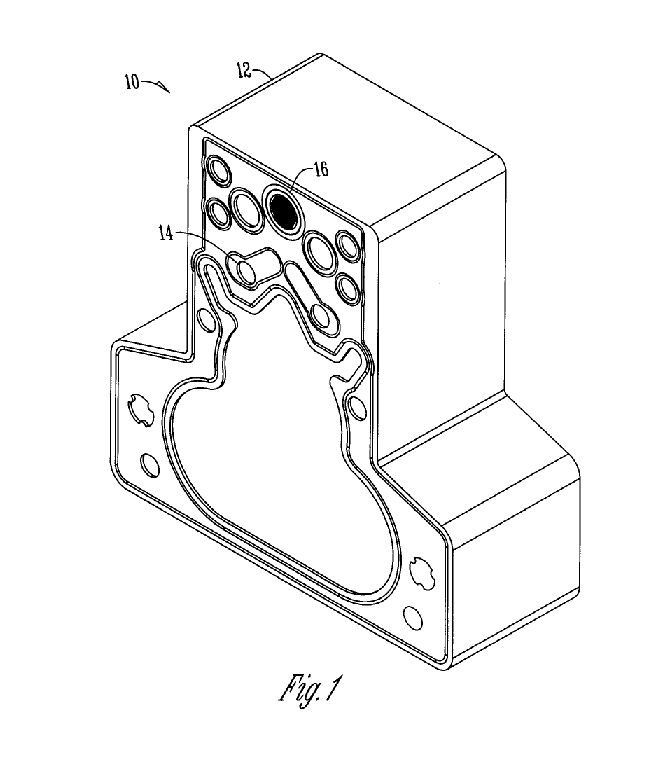

FIG. 1 shows a hydraulic unit 10 having a hydraulic housing 12 containing a plurality of fluid passageways 14. A gasket 16 is adapted to be secured to the housing 12 of the hydraulic unit 10 and allows fluid flow therethrough.

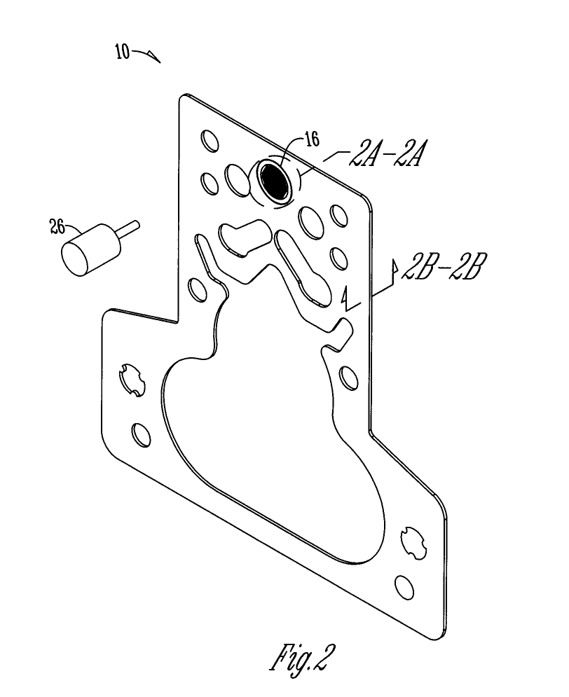

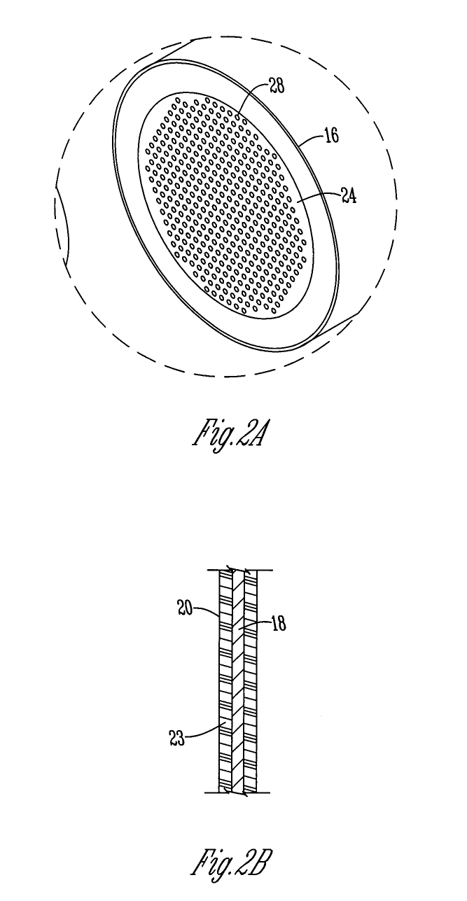

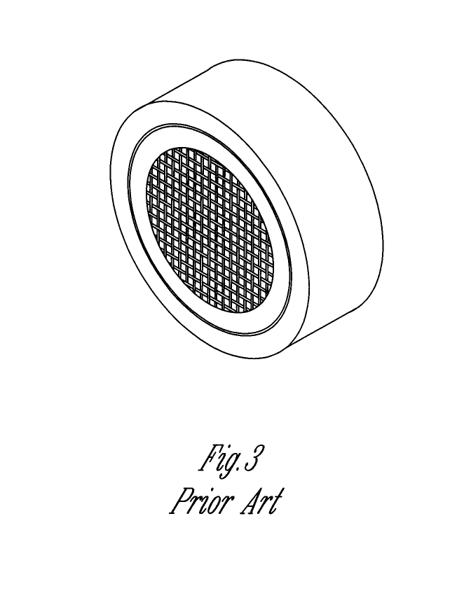

As best shown in FIG. 2 the gasket 16 has a metal body 18 with first and second sides 20, 22 that each has a rubber coating 23 thereon. In an area 24 the coating is burned off with a laser 26 and a plurality of laser made openings 28 are created in the area 24.

In operation to create the hydraulic unit 10 having gasket 16 the method of manufacturing the gasket 16 first involves the step of providing the metal body 18 that has first and second sides 20, 22. Then the first and second sides 20, 22 are coated with rubber 23. At this time a portion of the rubber coating 23 is burned off of both sides of the metal body 18 to create an area 24 on either side of the metal body 18. A plurality of openings 28 are then created by the laser 26 in the area 24. At this time the gasket is secured to the housing 12 such that hydraulic fluid can flow through the gasket 16 and yet contaminating particles are prevented from flowing through gasket 16 thus effectively filtering the hydraulic fluid within the hydraulic unit 10.

By using the laser 26 to create the gasket 16 having a plurality of openings 28 the need for a steel wire mesh screen for filtering is eliminated. Thus, the cost in manufacturing associated with creating this screen and the probability of part of the screen breaking off and contaminating the hydraulic fluid is also eliminated. Therefore, at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A gasket for a hydraulic housing comprising:
a metal body having first and second sides;
a coat of rubber on the first side and second side; and
a plurality of laser made openings within the metal body.

2. The gasket of claim 1 wherein the metal body comprises a steel sheet.

3. The gasket of claim 1 wherein the rubber is removed from an area on the metal body and wherein the plurality of openings are located in the area wherein the rubber is removed.

4. The gasket of claim 3 wherein the area is located on the metal body.

5. The gasket of claim 1 wherein the gasket is adapted to be secured to the hydraulic housing.

6. A method of manufacturing a gasket for a hydraulic housing steps comprising:
providing a metal body having a first and second side;
coating the first side and second side of the metal body with rubber; and
creating a plurality of openings within the metal body with a laser.

7. The method of claim 6 wherein the metal body comprises a steel sheet.

8. The method of claim 6 further comprising the step of removing a portion of the rubber from an area on the metal body before creating the plurality of openings.

9. The method of claim 8 where the plurality of openings are created where the rubber is removed.

10. The method of claim 8 wherein the area is located on the metal body.
